(19) United States
(12) Patent Application Publication
(10) Pub. No.: US 2011/0100616 A1
(43) Pub. Date: May 5, 2011

(54) Heat radiating structure and method for manufacturing the same

(75) Inventor: Cheol Ho Heo, Busan-si (KR)

(73) Assignee: Samsung Electro-Mechanics Co., Ltd., Suwon (KR)

(21) Appl. No.: 12/656,017

(22) Filed: Jan. 13, 2010

(30) Foreign Application Priority Data
Oct. 29, 2009 (KR) 10-2009-0103319

(51) Int. Cl. F28F 7/00; B05D 5/00; B32B 38/10

(52) U.S. Cl. 165/185; 427/261; 156/247

(57) ABSTRACT

The present invention provides a heat radiating structure including: a metal substrate having a front surface facing a light emitting device, a rear surface opposite to the front surface, and side surfaces connecting the front surface and the rear surface; an oxide film pattern covering the front surface of the metal substrate; an adhesive film covering the oxide film pattern; and a metal pattern formed on the adhesive film and having a heat transmission via bonded to the oxide film pattern through the adhesive film.

### CROSS-REFERENCE TO RELATED APPLICATIONS

This application claims the benefit of Korean Patent Application No. 10-2009-0103319 filed with the Korea Intellectual Property Office on Oct. 29, 2009, the disclosure of which is incorporated herein by reference.

### BACKGROUND OF THE INVENTION

1. Field of the Invention

The present invention relates to a heat radiating structure, and more particularly, to a heat radiating structure having improved heat radiating efficiency, and a method for manufacturing the same.

2. Description of the Related Art

In general, a light emitting device package is formed by packaging a light emitting device such as a light emitting diode (LED) and light emitting laser to provide the light emitting device in home appliances, remote controllers, electronic displays, indicators, automation equipment, lighting equipment, and so on. Recently, as the light emitting device has been applied to various fields, packaging technology for effectively treating heat generated from the light emitting device during operation of the light emitting device is required. Especially, in case of the high output LED applied to the lighting equipment, since it generates high temperature heat due to increase of power consumption, it is required to improve heat radiating efficiency of the light emitting device. Currently, heat radiation treatment of the LED is performed by radiating heat generated from the LED to the outside through a ceramic substrate used for mounting the LED. However, in this case, cost of the light emitting element package is increased due to a high price of the ceramic substrate. Further, there is a problem that the ceramic substrate has relatively low heat resistance and abrasion resistance.

### SUMMARY OF THE INVENTION

The present invention has been proposed in order to solve the above-described problems, and it is, therefore, an object of the present invention to provide a heat radiating structure having improved heat radiating efficiency.

Further, another object of the present invention is to provide a method for manufacturing a heat radiating structure having improved heat radiating efficiency.

In accordance with an aspect of the present invention to achieve the object, there is provided a heat radiating structure including: a metal substrate having a front surface facing a light emitting device, a rear surface opposite to the front surface, and side surfaces connecting the front surface and the rear surface; an oxide film pattern covering the front surface of the metal substrate; an adhesive film covering the oxide film pattern; and a metal pattern formed on the adhesive film and having a heat transmission via bonded to the oxide film pattern through the adhesive film.

In accordance with an embodiment of the present invention, the heat transmission via may be disposed in a region between the light emitting device and the metal substrate.

In accordance with an embodiment of the present invention, the metal substrate may be made of an aluminum material, and the oxide film pattern may include an aluminum oxide film.

In accordance with an embodiment of the present invention, the metal pattern may be made of a copper (Cu) material and may include a circuit line electrically connected to the light emitting device.

In accordance with an embodiment of the present invention, the oxide film pattern may be formed by anodizing the metal substrate.

In accordance with another aspect of the present invention to achieve the object, there is provided a method for manufacturing a heat radiating structure including the steps of: preparing a metal substrate having a front surface facing a light emitting device, a rear surface opposite to the front surface, and side surfaces connecting the front surface and the rear surface; forming a metal oxide film covering the front surface, the rear surface, and the side surfaces of the metal substrate; forming an adhesive film covering the metal oxide film formed on the front surface; forming a metal pattern, which has a heat transmission via bonded to the metal oxide film through the adhesive film, on the adhesive film; and removing the metal oxide film formed on the rear surface and the side surfaces.

In accordance with an embodiment of the present invention, the step of forming the metal pattern may include the steps of: forming a metal film covering the adhesive film; forming a via hole in the metal film and the adhesive film to expose the metal oxide film; and performing a plating process on a resulting structure in which the via hole is formed.

In accordance with an embodiment of the present invention, the step of preparing the metal substrate may include the step of preparing an aluminum plate, and the step of forming the metal oxide film may include the step of anodizing the aluminum plate.

In accordance with an embodiment of the present invention, the step of removing the metal oxide film formed on the rear surface and the side surfaces may include the step of performing a delamination process on a resulting structure in which the metal oxide film is formed.

In accordance with an embodiment of the present invention, the step of forming the metal pattern may include the steps of: laminating a copper foil on the adhesive film; and performing an etching process on the copper foil before the step of removing the metal oxide film.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing a heat radiating structure in accordance with an embodiment of the present invention;

FIG. 2 is a flow chart showing a method for manufacturing a heat radiating structure in accordance with an embodiment of the present invention;

FIGS. 3a to 3e are views for describing a manufacturing process of a heat radiating structure in accordance with an embodiment of the present invention; and

FIG. 4 is a view showing a light emitting device package having a heat radiating structure in accordance with an embodiment of the present invention.

### DETAILED DESCRIPTION OF THE PREFERRED EMBODIMENTS

The advantages and characteristics of the present invention and methods of achieving them will be apparent with reference to the following embodiments described in detail in conjunction with the accompanying drawings. However, the present invention is not limited to the following embodiments but may be embodied in various other forms. The embodiments are provided to complete the disclosure of the present invention and to completely inform a person with average knowledge in the art of the scope of the present invention. Like reference numerals refer to like elements throughout the present specification.

The terms used in the present specification are merely used to describe the embodiments and are not intended to limit the present invention. In the present specification, a singular form includes a plural form as long as not stated otherwise in related descriptions. The terms “comprise” and/or “comprising” do not exclude the existence or addition of one or more different components, steps, operations, and/or elements.

Hereinafter, a heat radiating structure in accordance with an embodiment of the present invention will be described in detail with reference to the accompanying drawings.

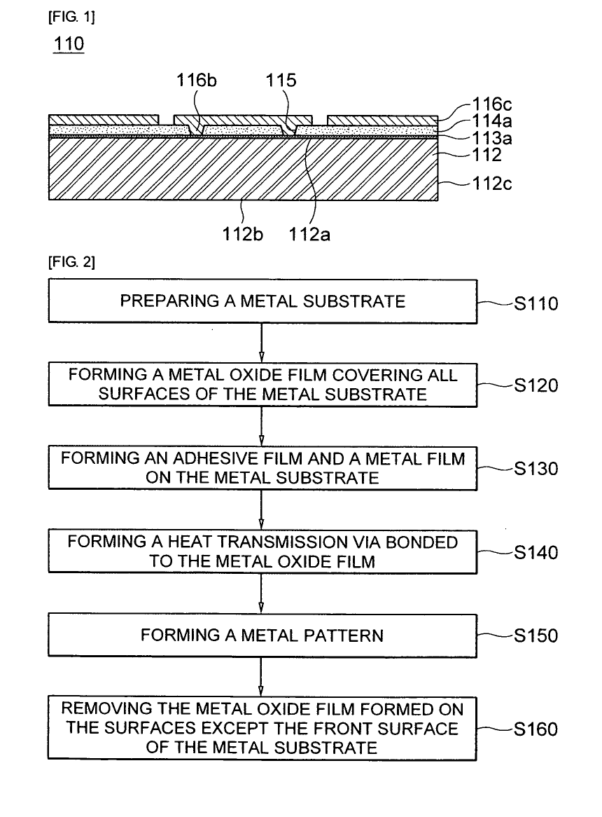

FIG. 1 is a view showing a heat radiating structure in accordance with an embodiment of the present invention. Referring to FIG. 1, a heat radiating structure 110 in accordance with an embodiment of the present invention includes a metal substrate 112, an adhesive film 114a, and a metal pattern 116c. The metal substrate 112 has a front surface 112a, a rear surface 112b opposite to the front surface 112a, and side surfaces 112c connecting the front surface 112a and the rear surface 112b. In case that the heat radiating structure 110 is coupled to a light emitting device structure (not shown), the front surface 112a is a surface facing the light emitting device structure. The metal substrate 112 is a plate made of a metal material having high thermal conductivity. As one example, the metal substrate 112 may be an aluminum (Al) substrate. The metal substrate 112 includes an oxide film pattern 113a. The oxide film pattern 113a is formed only on the front surface 112a of the metal substrate 112. The oxide film pattern 113a is formed by anodizing the metal substrate 112. Therefore, in case that the metal substrate 112 is an aluminum plate, the oxide film pattern 113a may be an Al₂O₃ film.

The adhesive film 114a is interposed between the metal substrate 112 and the metal pattern 116c. The adhesive film 114a is made of a predetermined insulating adhesive material, preferably having high thermal conductivity. This adhesive film 114a fixes the metal pattern 116c on the metal substrate 112 and effectively transmits heat from the metal pattern 116c to the metal substrate 112. Meanwhile, a pre-preg layer may be further provided in the adhesive film 114a.

The metal pattern 116c covers the adhesive film 114a. The metal pattern 116c is made of a metal material having high thermal conductivity. As one example, the metal pattern 116c may include a copper foil made of copper (Cu). This metal pattern 116c is used as a heat transmitter for effectively transmitting heat radiated from a light emitting device to the metal substrate 112 and as a circuit line electrically connected to the light emitting device. Further, the metal pattern 116c includes a heat transmission via 116b bonded to the oxide film pattern 113a. For example, the heat transmission via 116b may be directly bonded to the adhesive film 114a. At least one heat transmission via 116b is provided, and In case that a plurality of heat transmission vias 116b are provided, disposition of the heat transmission vias 116b may be variously changed in a region between the light emitting device and the metal substrate 112.

Meanwhile, although the present embodiment describes an example in which the oxide film pattern 113a is formed only on the front surface 112a of the metal substrate 112, a portion of the metal substrate 112, where the oxide film pattern 113a is to be formed, may be variously changed and modified. For example, the oxide film pattern 113a of the metal substrate 112 may be formed to cover at least one of the rear surface 112b and the side surfaces 112c as well as the front surface 112a.

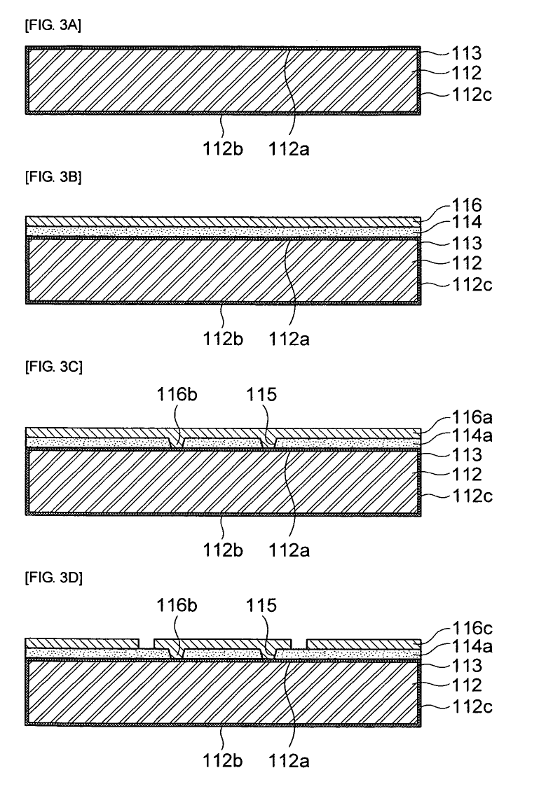

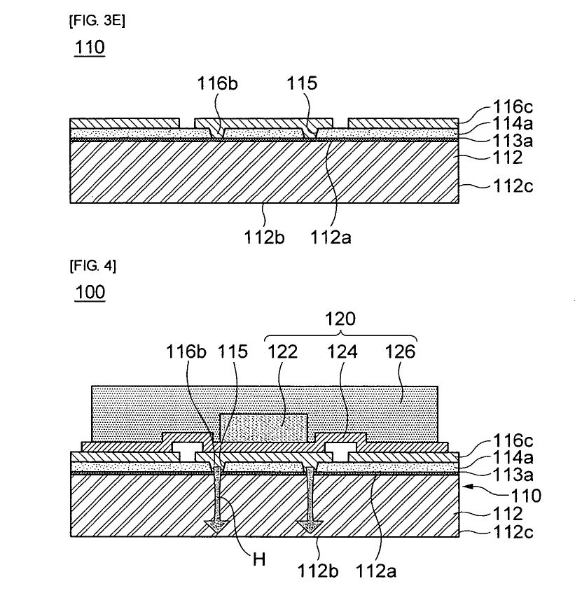

FIG. 2 is a flow chart showing a method for manufacturing a heat radiating structure in accordance with an embodiment of the present invention, and FIGS. 3a to 3e are views for describing a manufacturing process of a heat radiating structure in accordance with an embodiment of the present invention.

Referring to FIGS. 2 and 3a, a metal substrate 112 is prepared (S110). For example, the step of preparing the metal substrate 112 may include the step of preparing an aluminum substrate having a front surface 112a, a rear surface 112b opposite to the front surface 112a, and side surfaces 112c connecting the front surface 112a and the rear surface 112b.

A metal oxide film 113 is formed to cover all the surfaces 112a, 112b, and 112c of the metal substrate 112 (S120). For example, the step of forming the metal oxide film 113 may be performed by anodizing the metal substrate 112. The anodizing is one of electrochemical metal oxidation methods, which forms a stable oxide film on a surface of the metal substrate 112. In case that the metal substrate 112 is an aluminum substrate, the metal oxide film 113, which is an aluminum oxide film, is formed by the anodizing to cover the front surface 112a, the rear surface 112b, and the side surfaces 112c of the metal substrate 112. This metal oxide film 113 prevents rusting of the metal substrate 112 and improves abrasion resistance, heat resistance, and adhesion of the metal substrate 112.

Referring to FIGS. 2 and 3b, an adhesive film 114 and a metal film 116 are sequentially formed on the metal substrate 112 (S130). For example, the adhesive film 114 having high thermal conductivity is formed on the front surface 112a of the metal substrate 112. A fluorine resin adhesive such as Teflon may be used as the adhesive film 114. And, the metal film 116 is formed on the adhesive film 114. For example, the step of forming the metal film 116 may be performed by laminating a copper foil including copper (Cu) on the adhesive film 114. In a process of attaching the metal film 116 to the adhesive film 114, a predetermined pressure may be applied to prevent separation of the metal film 116 from the adhesive film 114.

Referring to FIGS. 2 and 3c, a heat transmission via 116b is formed to be bonded to the metal oxide film 113 (S140). For example, a via hole 115 is formed in the metal film 116 of FIG. 3b and the adhesive film 114 of 3b to expose the metal oxide film 113. As one example, the step of forming the via hole 115 may be performed by a photoresist etching process on the metal film 116 and the adhesive film 114. As another example, the step of forming the via hole 115 may be performed by irradiating laser to the metal film 116 and the adhesive film 114 or using a predetermined drill. Accordingly, an adhesive film 114a and a metal film 116a having at least one via hole 115 exposing the metal oxide film 113 are formed on the front surface 112a of the metal substrate 112. After that, the heat transmission via 116b is formed to fill the via hole 115. As one example, the step of forming the heat transmission via 116b may perform a plating process on a resulting structure in which the via hole 115 is formed. The plating process may be one of an electroless plating process or an electroplating process, and thus a metal via is formed in the via hole 115. Accordingly, the metal film 116a having the heat transmission via 116b directly bonded to the metal oxide film 113 is formed on the metal substrate 112.

Referring to FIGS. 2 and 3d, a metal pattern 116c is formed (S150). For example, the step of forming the metal pattern 116c is performed by a predetermined etching process on the metal film 116a of FIG. 3c. As one example, the etching process may include a photoresist etching process. As another example, the etching process may include a process of processing the metal film 116a with laser or a drill. The metal pattern 116c, which is manufactured by the above methods, is used as a circuit line for transmitting an electrical signal to a light emitting device (not shown) and as a heat transmitter for transmitting heat generated from the light emitting device to the metal substrate 112.

Meanwhile, in a process of forming the metal pattern 116c, the metal oxide film 113 prevents damage to the metal substrate 112. More specifically, when forming the metal pattern 116c by a method such as the photoresist etching process, since the metal substrate 112 is affected by the etching process, damage such as corrosion and unnecessary etching may be generated in the metal substrate 112. In order to prevent this, the metal oxide film 113 covers the rear surface 112b and the side surfaces 112c as well as the front surface 112a of the metal substrate 112 to protect the metal substrate 112 from etching process environment, thereby preventing the damage to the metal substrate 112 in the etching process.

Referring to FIGS. 2 and 3e, the metal oxide film 113 of FIG. 3d formed on the surfaces 112b and 112c except the front surface 112a of the metal substrate 112 is removed (S160). For example, the step of removing the metal oxide film 113 is performed by a predetermined delamination process on a resulting structure in which the metal pattern 116c is formed. At this time, the adhesive film 114a and the metal pattern 116c prevent delamination of the metal oxide film 113 formed on the front surface 112a of the metal substrate 112. Accordingly, the delamination process selectively delaminates the metal oxide film 113 formed on the rear surface 112b and the side surfaces 112c of the metal substrate 112. Consequently, by the delamination process, an oxide film pattern 113a, which covers only the front surface 112a, is formed on the metal substrate 112.

Meanwhile, although the present embodiment describes an example in which the metal oxide film 113 covering the rear surface 112b and the side surfaces 112c of the metal substrate is removed, a portion from which the metal oxide film 113 is removed may be variously changed and modified. Further, manufacture of a heat radiating structure 110 shown in FIG. 1 may be completed without a process of removing the metal oxide film 113. In this case, the final heat radiating structure 110 may have the metal oxide film 113 which covers all of the front surface 112a, the rear surface 112b, and the side surfaces 112c of the metal substrate 112.

The heat radiating structure 110 in accordance with the above-described embodiment of the present invention includes the metal substrate 112 having high thermal conductivity, the oxide film pattern 113a, and the metal pattern 116c. Here, the metal pattern 116c has the heat transmission via 116b directly bonded to the oxide film pattern 113a. Since the heat radiating structure 110 of this structure increases a heat transmission rate from the metal pattern 116a to the metal substrate 112 by the heat transmission via 116b, it is possible to improve heat radiating efficiency of the heat radiating structure 110.

Further, in accordance with an embodiment of the present invention, the metal pattern 116c is formed on the metal substrate 112 in a state of covering all the surfaces 112a, 112b, and 112c of the metal substrate 112 with the metal oxide film 113. Accordingly, the present invention prevents the damage to the metal substrate 112 in the process of forming the metal pattern 116c by protecting the metal substrate 112 with the metal oxide film 113.

Hereinafter, one example of a light emitting device package 100 including a heat radiating structure 110 in accordance with the above-described embodiment of the present invention will be described. Here, repeated descriptions of the above-described heat radiating structure 110 will be omitted or simplified.

FIG. 4 is a view showing a light emitting device package including a heat radiating structure in accordance with an embodiment of the present invention. Referring to FIG. 4, the light emitting device package 100 is manufactured by coupling the heat radiating structure 110 described above with reference to FIG. 1 to a predetermined light emitting device structure 120. Here, the light emitting device structure 120 is coupled on a metal pattern 116c formed on a front surface 112a of a metal substrate 112. The light emitting device structure 120 includes a light emitting device 122, a lead frame 124, and a molding film 126. The light emitting device 122 is at least one of a light emitting diode or a laser diode. As one example, the light emitting device 122 may be a light emitting diode. The lead frame 124 is electrically connected to the light emitting device 122 and the metal pattern 116c. This lead frame 124 transmits an electrical signal between the light emitting device 122 and the metal pattern 116c. And, the molding film 126 covers the light emitting device 122 to protect the light emitting device 122 from external environment.

In the light emitting device package 100 in accordance with the above-described embodiment of the present invention, heat H generated from the light emitting device 122 is conducted to the metal substrate 112 through a heat transmission via 116b of the metal pattern 116c, and the metal substrate 112 radiates the heat H to the outside. At this time, some of the heat H generated from the light emitting device 122 is radiated to the outside through the metal pattern 116c, the adhesive film 114a, and the metal substrate 112. Accordingly, the light emitting device package 100 improves heat radiating efficiency of the light emitting device 122 by having a heat radiating structure 110 including the heat transmission via 116a which effectively conducts the heat H of the light emitting device 122 to the metal substrate 112.

The heat radiating structure in accordance with the present invention includes the metal substrate and the oxide film pattern having high thermal conductivity, the adhesive film, and the metal pattern having the heat transmission via bonded to the oxide film pattern through the adhesive film, which are sequentially stacked on the front surface of the metal substrate. When the heat radiating structure of this structure is coupled with the light emitting device structure, the heat radiating structure has a structure in which the heat generated from the light emitting device structure is effectively transmitted to the metal substrate through the heat transmission via, and then the metal substrate radiates the heat to the outside. Accordingly, the heat radiating efficiency of the heat radiating structure in accordance with the present invention is improved.

The method for manufacturing the heat radiating structure in accordance with the present invention manufactures the heat radiating structure which includes the metal substrate and the oxide film pattern having high thermal conductivity, the adhesive film, and the metal pattern having the heat transmission via bonded to the oxide film pattern through the adhesive film, which are sequentially stacked on the front surface of the metal substrate. When the heat radiating structure of this structure is coupled with the light emitting device structure, the heat radiating structure has a structure in which the heat generated from the light emitting device structure is effectively transmitted to the metal substrate through the heat transmission via, and then the metal substrate radiates the heat to the outside. Accordingly, the method for manufacturing the heat radiating structure in accordance with the present invention manufactures the heat radiating structure with the improved heat radiating efficiency.

The method for manufacturing the heat radiating structure in accordance with the present invention prevents the damage to the metal substrate by the metal oxide film in the process of forming the metal pattern by forming the metal pattern on the metal substrate in a state of protecting the metal substrate with the metal oxide film.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. A heat radiating structure radiating heat generated from a light emitting device, the heat radiating structure comprising:
a metal substrate having a front surface facing the light emitting device, a rear surface opposite to the front surface, and side surfaces connecting the front surface and the rear surface;
an oxide film pattern covering the front surface of the metal substrate;
an adhesive film covering the oxide film pattern; and
a metal pattern formed on the adhesive film and having a heat transmission via bonded to the oxide film pattern through the adhesive film.

2. The heat radiating structure according to claim 1, wherein the heat transmission via is disposed in a region between the light emitting device and the metal substrate.

3. The heat radiating structure according to claim 1, wherein the metal substrate is made of an aluminum material, and the oxide film pattern includes an aluminum oxide film.

4. The heat radiating structure according to claim 1, wherein the metal pattern is made of a copper (Cu) material and includes a circuit line electrically connected to the light emitting device.

5. The heat radiating structure according to claim 1, wherein the oxide film pattern is formed by anodizing the metal substrate.

6. A method for manufacturing a heat radiating structure radiating heat generated from a light emitting device, the method comprising:
preparing a metal substrate having a front surface facing the light emitting device, a rear surface opposite to the front surface, and side surfaces connecting the front surface and the rear surface;
forming a metal oxide film covering the front surface, the rear surface, and the side surfaces of the metal substrate;
forming an adhesive film covering the metal oxide film formed on the front surface;
forming a metal pattern, which has a heat transmission via bonded to the metal oxide film through the adhesive film, on the adhesive film; and
removing the metal oxide film formed on the rear surface and the side surfaces.

7. The method according to claim 6, wherein forming the metal pattern includes:
forming a metal film covering the adhesive film;
forming a via hole in the metal film and the adhesive film to expose the metal oxide film; and
performing a plating process on a resulting structure in which the via hole is formed.

8. The method according to claim 6, wherein preparing the metal substrate includes preparing an aluminum plate, and forming the metal oxide film includes anodizing the aluminum plate.

9. The method according to claim 6, wherein removing the metal oxide film formed on the rear surface and the side surfaces includes performing a delamination process on a resulting structure in which the metal oxide film is formed.

10. The method according to claim 6, wherein forming the metal pattern includes:
laminating a copper foil on the adhesive film; and
performing an etching process on the copper foil before removing the metal oxide film.
